(19) United States
(12) Patent Application Publication
(10) Pub. No.: US 2023/0358659 A1
(43) Pub. Date: Nov. 9, 2023

(54) Method for Determining a Physical Parameter of a Fluid in a Pipe-Fluid System

(71) Applicant: ABB Schweiz AG, Baden (CH)

(72) Inventors: Paul Szasz, Plankstadt (DE); Vadim Migunov, Ladenburg (DE)

(73) Assignee: ABB Schweiz AG, Baden (CH)

(21) Appl. No.: 18/308,820

(22) Filed: Apr. 28, 2023

(30) Foreign Application Priority Data
May 4, 2022 (EP) 22171523.8

(51) Int. Cl. G01N 9/24; G01L 9/00; G01F 1/66

(52) U.S. Cl. CPC G01N 9/24; G01L 9/0008; G01F 1/66; G01N 2011/0073

(57) ABSTRACT

A system and method for determining a physical parameter of a fluid in a pipe includes performing a numerical vibration simulation of the section of the pipe resulting in a computed Eigen-frequency range of computed maxima; inducing a first vibration and acquiring first maxima in an amplitude-frequency diagram; selecting a first hoop mode maximum and inducing a second vibration to acquire second maxima with a second frequency. Using a vibration mode analysis, a second hoop mode maximum is selected and the physical parameter of the fluid is derived from a difference between the first hoop mode maximum and the second hoop mode maximum.

### CROSS-REFERENCE TO RELATED APPLICATIONS

This patent application claims priority to European Patent Application No. 22171523.8, filed on May 4, 2022, which is incorporated herein in its entirety by reference.

### FIELD OF THE DISCLOSURE

The present disclosure generally relates to the field of determining a physical parameter of a fluid, particularly in a pipe-fluid system.

### BACKGROUND OF THE INVENTION

Many methods and devices have been developed so far to extract various physical parameters of a process fluid in industrial pipelines by means of a vibration frequency spectrum of the pipe or pipeline. However, it turned out that selecting a best-suited frequency out of the full vibration frequency spectrum is crucial for determining a physical parameter of a fluid with good precision, particularly because not all vibration modes are equally sensitive to any selected physical parameter of the fluid.

### BRIEF SUMMARY OF THE INVENTION

In an embodiment, the present disclosure describes an improved method for determining a physical parameter of a fluid. One particular aspect relates to a method for determining a physical parameter of a fluid in a section of a pipe-fluid system, wherein the pipe-fluid system comprises a pipe configured to be filled with the fluid. The method comprises: selecting the section of the pipe-fluid system, the section being delimited by a pair of stiff delimiters; performing a numerical vibration simulation of the section of the pipe, resulting in a computed Eigen-frequency range of computed maxima of the pipe-fluid system; inducing, by an excitation means, a first vibration of the section; acquiring, by at least two vibration measurement devices, a set of first maxima in an amplitude-frequency diagram, with a first frequency within the computed Eigen-frequency range; selecting, by means of a vibration mode analysis, a first hoop mode maximum out of the set of first maxima; inducing, by the excitation means, a second vibration of the section; acquiring, by the at least two vibration measurement devices, a set of second maxima in the amplitude-frequency diagram, with a second frequency within the computed Eigen-frequency range; selecting, by means of vibration mode analysis, a second hoop mode maximum out of the set of second maxima; and deriving the physical parameter of the fluid from a difference between the first hoop mode maximum and the second hoop mode maximum.

### BRIEF DESCRIPTION OF THE SEVERAL VIEWS OF THE DRAWING(S)

FIG. 1 is a schematic representation of a vibration measurement system and a pipe-fluid system according to an embodiment of the present disclosure.

FIGS. 2a and 2b are schematics of hoop modes of a pipe-fluid system according to an embodiment of the present disclosure.

FIG. 3 is a schematic of bending modes of a pipe-fluid system according to an embodiment of the present disclosure.

FIG. 4 is a schematic of an amplitude-frequency diagram according to an embodiment of the present disclosure.

FIGS. 5a, 5b, and 5c are schematics of pipe-fluid systems with vibration measurement devices according to an embodiment of the present disclosure.

FIG. 6a is a schematic of a pipe-fluid system with vibration measurement devices according to an embodiment of the present disclosure.

FIG. 6b is a schematic of a plurality of hoop modes of a pipe-fluid system according to an embodiment of the present disclosure.

FIG. 7 is a flowchart of a method in accordance with the present disclosure.

### DETAILED DESCRIPTION OF THE INVENTION

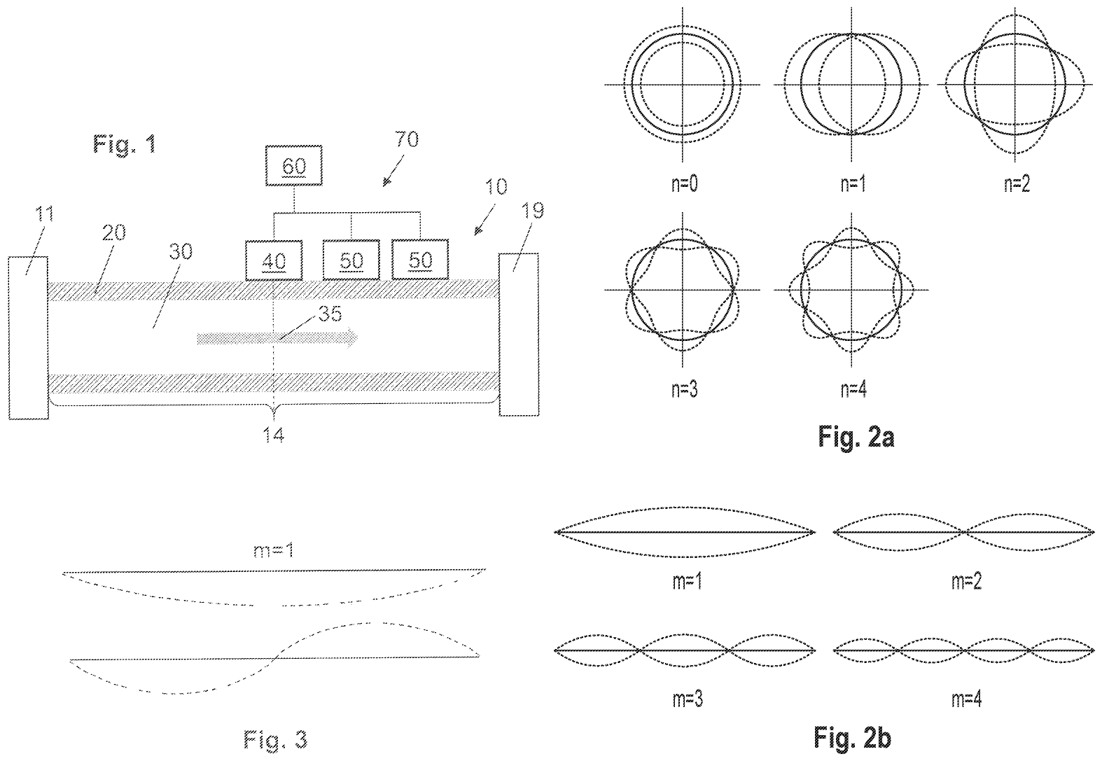

FIG. 1 shows schematically a vibration measurement system 70 and a pipe-fluid system 10 according to an embodiment. The pipe-fluid system 10 comprises a pipe 20 with fluid 30. The fluid 30 may be steady or flow in a direction marked by arrow 35. The pipe-fluid system 10 is delimited by a pair of delimiters 11 and 19, e.g., by clamps, flanges and/or other delimiting means, thus building a section 14.

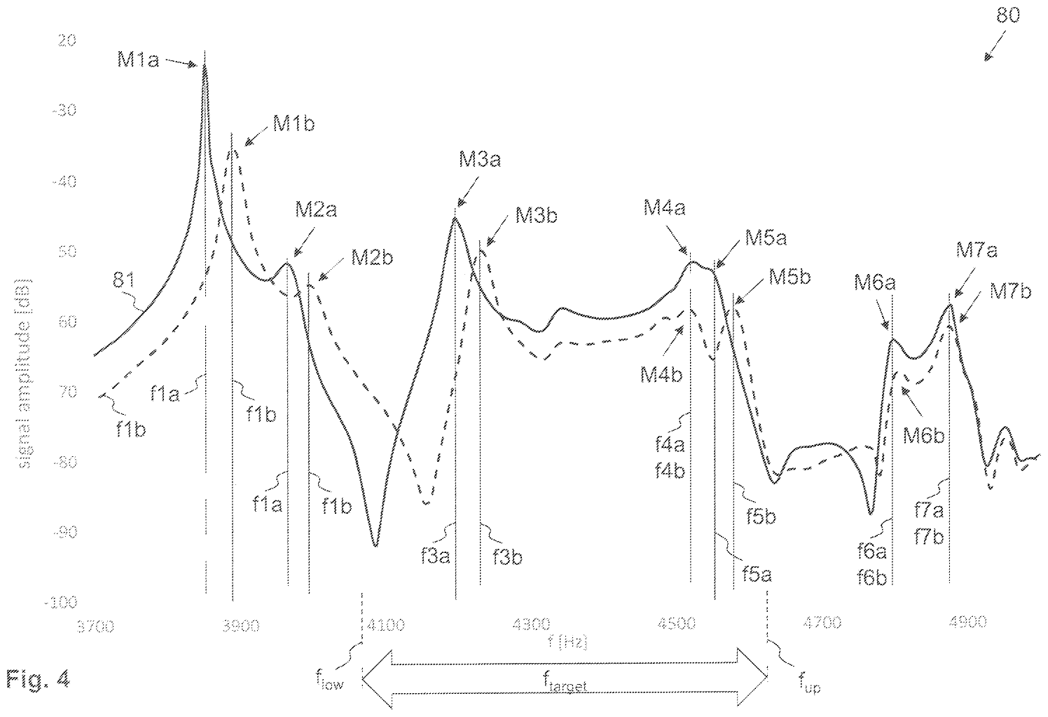

The vibration measurement system 70 configured for determining a physical parameter of a fluid in the pipe-fluid system 10, particularly in section 14. The vibration measurement system 70 comprises an excitation means 40, e.g., a hammer. The excitation means 40 may be fixed (not shown) on one of the delimiters 11 and 19. The excitation means is configured for inducing a vibration in the section 14. Additionally, the vibration measurement system 70 comprises at least two vibration measurement devices 50. The vibration measurement devices 50 may be mounted on an outside of the pipe 20, and/or comprise distant measurement means (not shown), for example a laser sensor. The vibration measurement devices 50 are configured for acquiring responses of a punch by means of the excitation means 40. The responses may be depicted as an amplitude-frequency diagram; see e.g., FIG. 4. Further, the vibration measurement system 70 comprises an evaluation device 60. The evaluation device 60 may control the excitation means 40 and/or the vibration measurement devices 50. Besides, the evaluation device 60 may be configured for executing at least some of the steps of a method as described above and/or below, particularly for determining at least one physical parameter of the fluid 30.

FIGS. 2a and 2b show schematically radial and axial deformation shapes of hoop modes of a vibrating pipe-fluid system 10 (see, e.g., FIG. 1) according to an embodiment. FIG. 2a shows a radial movement shape (cross-section variation) of potential hoop modes, from n=0 to n=4, n being defined by the half the number of vibrational nodes around the circumference, i.e., points which do not move. FIG. 2b shows an axial movement shape (varying amplitude of cross-section variation shown in FIG. 3 along the pipe length) of any hoop mode, with m=1 to m=4, m being defined by the number of radial vibration maxima along the system length. Specific cross sections of the pipe “blow up” or expand locally and periodically within each m section while vibrating.

FIG. 3 shows schematically deformations caused by the first two bending modes of a pipe section. The pipe bends longitudinally without changing the cross-section while vibrating.

FIG. 4 shows schematically an amplitude-frequency diagram 80 according to an embodiment. The amplitude-frequency diagram 80 is an example of a response or reaction on exciting the pipe-fluid system 10, e.g., by excitation means 40. Note that for determining a physical parameter of a fluid such an amplitude-frequency diagram 80 needs not necessarily be depicted, but only its properties may be used.

The amplitude-frequency diagram 80 depicts a first curve 81 and a second curve 82. The first curve 81 has first maxima M1a-M7a, with respective first frequencies f1a-f7a. The second curve 82 (with broken lines) has second maxima M1b-M7b, with respective second frequencies f1b-f1b. The first curve 81 is acquired, by the vibration measurement devices 50, as response of a first vibration of the section 14. The first curve 81 may have been acquired to get reference values for measurements. The second curve 82 is acquiring, by the same vibration measurement devices 50, as response of a second vibration of the section 14. The first curve 81 may be acquired, particularly on a regular basis, to get “productive values” of a current situation of the pipe-fluid system 10. Furthermore, FIG. 4 shows a computed Eigen-frequency range ftarget of computed maxima (those maxima are not shown) of the pipe-fluid system 10, within which the frequency correlated to the envisaged physical property is expected. The computed Eigen-frequency range ftarget may be result of a simulation, e.g., of an FEM-simulation, of the pipe-fluid system 10. Due to several frame-conditions, as explained above, the simulation has not a single Eigen-frequency as result, but a frequency range, i.e., an Eigen-frequency range ftarget.

After acquiring, by the vibration measurement devices 50, the first maxima M1a-M7aof the first curve 81, the maxima M1a, M2a, M6a, M7a can be excluded from evaluation, because these maxima are outside the computed Eigen-frequency range ftarget. Hence, a set of first maxima {M3a, M4a, M5a} remains. Then, a vibration mode analysis is conducted, e.g., using phase analysis of the at least two vibration measurement devices 50. As a result, it turns out that maxima M4a and M5a have the same phase. This means that M5a and M5a are bending mode maxima and, thus, are also excluded from evaluation. Consequently, a first hoop mode maximum M3a out of the set of first maxima {M3a, M4a, M5a} remains or is selected, with a frequency f3a, which can be used as reference frequency.

In the “productive phase”, second maxima M1a-M7a, of the second curve 82, are acquired. Then, the maxima M1b, M2b, M6b, M7b are excluded from evaluation, because these maxima are out of the computed Eigen-frequency range ftarget, thus leading to a remaining set of second maxima {M3b, M4b, M5b }. From this set of second maxima {M3b, M4b, M5b}, second hoop mode maximum M3b is selected, because it turns out—by means of a vibration mode analysis—that M3b is a hoop mode maximum, and the M4b and M5b are bending mode maxima. For deriving the physical parameter of the fluid, a difference between the first hoop mode maximum M3a and the second hoop mode maximum M3b is used.

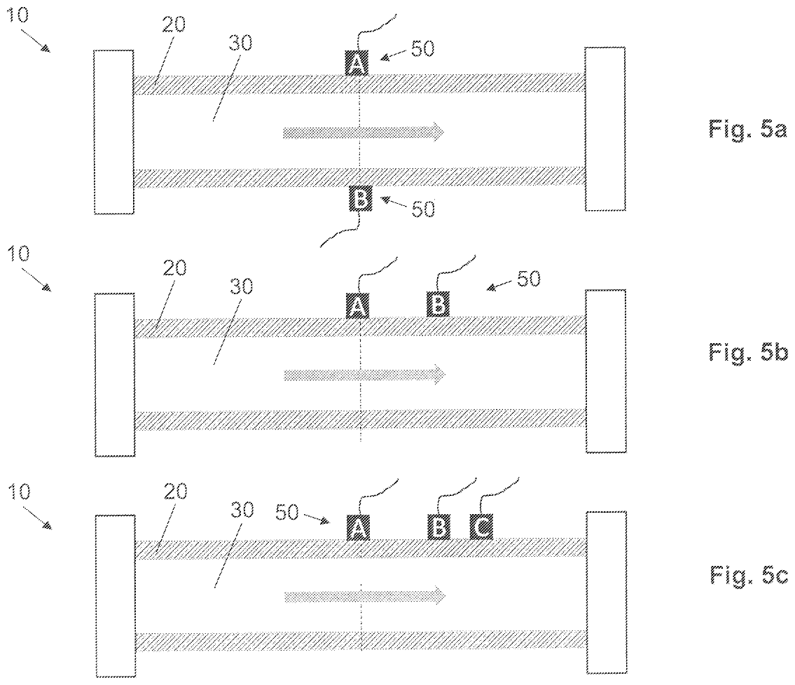

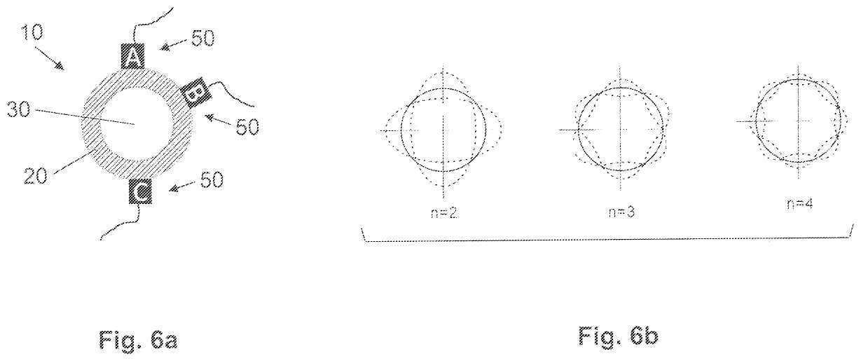

FIGS. 5a to 5c shows schematically pipe-fluid systems 10 with pipe 20, fluid 30 and at least two vibration measurement devices 50—depicted as A, B (and, optionally, C)—according to an embodiment. In FIG. 5a, two vibration measurement devices A and B are shown, arranged along one line radially circumferential to the pipe 20. Looking at FIG. 3 or FIG. 6b, it becomes clear that this arrangement fits well for detecting phases that indicate hoop mode. In FIG. 5b, two vibration measurement devices A and B are shown, arranged at an outer surface of the pipe 20, along one line axially parallel to the pipe 20. In FIG. 5c, two vibration measurement devices A and B are shown, arranged at an outer surface of the pipe 20, along one line axially parallel to the pipe 20.

FIG. 6a shows schematically a pipe-fluid system 10 with vibration measurement devices 50 (A, B, C) according to an embodiment. Particularly, three vibration measurement devices A, B and C are shown, arranged along one line radially circumferential to the pipe 20.

FIG. 6b show schematically hoop modes of a pipe-fluid system according to an embodiment, with n=1 to n=4. The phases of the bending modes and the hoop modes are clearly visible in FIG. 2 or FIG. 3, respectively.

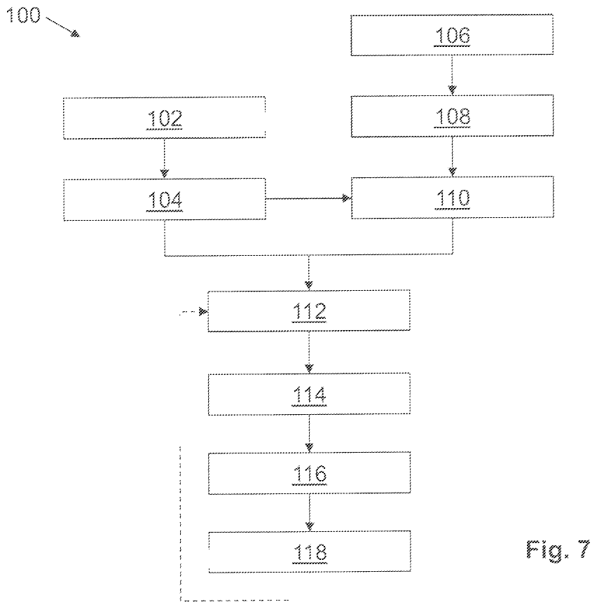

FIG. 7 shows a flow diagram 100 depicting a method for determining a physical parameter of a fluid 30 in a section 14 of a pipe-fluid system 10 (see, e.g., FIG. 1)

according to an embodiment. In a step 102, a section 14 of the pipe-fluid system 10 is selected, wherein the section 14 is delimited by a pair of stiff delimiters 11, 19. In a step 104, a numerical vibration simulation of the section 14 of the pipe 20 is performed, resulting in a computed Eigen-frequency range ftarget of computed maxima of the pipe-fluid system 10. In a step 106, by an excitation means 40, a first vibration of the section 14 is induced. In a step 108, by at least two vibration measurement devices 50, a set of first maxima {M3a, M4a, M5a} (e.g., using an amplitude-frequency diagram 80, or at least its semantic) is acquired, with a first frequency f3a, f4a, f5a within the Eigen-frequency range ftarget. In a step 110, by means of a vibration mode analysis, a first hoop mode maximum M3a out of the set of first maxima {M3a, M4a, M5a} is selected.

In a step 112, by the excitation means 40, a second vibration of the section 14 is induced. In a step 114, by the at least two vibration measurement devices 50, a set of second maxima {M3b, M4b, M5b} is acquired, with a second frequency f3b, f4b, f5b within the Eigen-frequency range ftarget. In a step 116, by means of vibration mode analysis, a second hoop mode maximum M3b out of the set of second maxima {M3b, M4b, M5b} is selected. In a step 118, the physical parameter of the fluid 30 are derived from a difference between the first hoop mode maximum M3a and the second hoop mode maximum M3b.

### LIST OF REFERENCE SYMBOLS

10 pipe-fluid system
11, 19 delimiters
14 section of the pipe
20 pipe
30 fluid
35 arrow
40 excitation means
50, A, B, C vibration measurement device
60 evaluation device
70 vibration measurement system
80 amplitude-frequency diagram
81 first curve
82 second curve
100 flow diagram
102-118 steps
M1a-M7afirst maxima
M1b-M7b second maxima
f1a-f7a first frequency
f1b-f7b second frequency

In the context of the present disclosure, the physical parameter of the fluid may be, e.g., pressure, a viscosity and/or a density of the fluid. The fluid may be any material, which can be transported in a pipeline or pipe. Examples may comprise a liquid, a suspension, and/or a gas, for instance a liquefied gas. The pipe-fluid system comprises a pipe that is configured to be filled with said fluid. The pipe may comprise any material, which is able to vibrate as response to a single stimulus. The stimulus may be given by punching with a hammer, any other tool or with a knuckle on the pipe. The tool to be used may comprise a tool with defined force-impact on the pipe. The section of the pipe-fluid system may be a section of the pipe that is delimited by rigid means, such as a clamp or a flange, on each side of the section. The length of the section may be determined by the dimensions of the pipe. Selecting the section of the pipe-fluid system may comprise to build and/or to use a section of the pipe-fluid system that is delimited by a pair of stiff delimiters. The pipe may be filled essentially completely with the fluid in the selected section.

The numerical vibration simulation of the section of the pipe may comprise an analytical or an FEM-based (Finite Element Method) simulation of the selected section. The vibration simulation of the pipe-fluid system may consider both physical properties of the pipe and physical properties of the fluid. The vibration simulation may be the simulation of a response to one single stimulus, for example to one single punch with a hammer on the pipe section. The response-frequency or resonant frequency to one single stimulus is often called the Eigen-frequency of the pipe-fluid system. The vibration simulation may result in an amplitude-frequency diagram, i.e., a diagram that shows frequencies of the vibrating section on an x-axis of the diagram and amplitudes on a y-axis of the diagram. Hence, computed maxima in the amplitude-frequency diagram are peaks in the diagram with an amplitude as y-value and a frequency as x value. The vibration simulation of the pipe-fluid system may result in a computed Eigen-frequency value that may differ, particularly differ between 0% and 10%, e.g., between 0% and 5%, from the actual Eigen frequency of the respective real pipe-fluid system. Thus, the computed Eigen-frequency is rather handled as a range, within which the vibration mode correlated to the envisaged fluid property is expected. The “range” may consider, for example, variations of the fluid, e.g., variations of its pressure, viscosity and/or density, variations of the pipe, e.g., caused by temperature fluctuations, precision deficiencies of the simulation and/or of the section's model and/or further sources of imprecision.

In other words, for determining a fluid property change from the vibrations of an arbitrary pipe-fluid system with a clamp-on method, the frequency of the vibration mode, which is known to be sensitive to the considered physical property, can be determined by appropriate model calculations. Its accuracy is typically within a range of a few percent of the determined physical property, e.g., within a frequency interval of 5-10%. This prediction may also be used to identify the relevant mode in a real vibration spectrum. However, the actual frequency of any predicted mode typically deviates slightly from the predicted value due to tolerances in dimensions and material data, so that in some cases several frequencies can be found within the predicted frequency interval. Hence, the method disclosed provides a means to select the envisaged vibration mode frequency from a multitude of Eigen-frequencies within the predicted frequency interval, which may result in a correlation between frequency change and fluid property change.

After the simulation-alternatively parallel to it, or even before it—some “real-world reference values” of the section of the pipe-fluid system may be captured. For this, a first vibration of the section is induced, by an excitation means, e.g., by one punch of a hammer, a solenoid system or other excitation means. The response of the section is acquired by at least two vibration measurement devices. The at least two vibration measurement devices may be arranged in a defined way, particularly to be able to determine vibration modes, i.e., hoop mode or bending mode of a maximum. Particularly, at least two vibration measurement devices (e.g., accelerometers) may be used to discriminate different modes within a pre-defined frequency interval.

The acquiring may result in a set of first maxima in an amplitude-frequency diagram, with a first frequency within the Eigen-frequency range. The set of first maxima may comprise one maximum only or several maxima; at least for some pipe-fluid systems, the latter may be the regular case. Hence, by limiting the maxima of the full vibration frequency spectrum to only the set of first maxima within the Eigen-frequency range already improves the method for determining a physical parameter of a fluid, by thus selecting a best-suited frequency, or at least only few of them (i.e., the set of first maxima).

For an even more sophisticated selection of the best-suited frequency, a vibration mode analysis is performed. The vibration mode analysis may differentiate bending mode maxima from hoop mode maxima. Particularly, bending mode maxima have essentially the same amplitude and the same phase measured by the at least two vibration measurement devices. In contrast, hoop mode maxima may have essentially the same amplitude, but a significantly different phase measured by the at least two vibration measurement devices.

In numerous experiments, it turned out that using a hoop mode maximum is better suited for determining at least some physical parameters of a fluid in a pipe-fluid system, for instance for determining a pressure, a viscosity and/or a density of the fluid. For determining these kind of parameters, the bending mode maxima are discarded and only the first hoop mode maximum, out of the set of first maxima, is used. The first hoop mode maximum may, then, be used as a reference value for the analysis.

It should be noted that, particularly for other kind of physical parameters—for instance for determining a flow of the fluid—, bending mode maxima may be used instead of the hoop mode maxima. Consequently, in these cases the hoop mode maxima are discarded.

After these “preparing steps”—which may be performed rarely, in some cases only once—the “productive steps” may be entered, which need to be done to get the at least one physical parameter of the fluid, e.g., on a regular basis.

For this, a second vibration of the section is induced by the excitation means. Then, as a response, a set of second maxima is acquired by the at least two vibration measurement devices, with a second frequency—of each one of the maxima—within the Eigen-frequency range. From this set of second maxima a second hoop mode maximum is selected, by means of vibration mode analysis. The inducing, the acquiring and the selecting may be done in an analogous way as for capturing the first hoop mode maximum.

Having the first hoop mode maximum as reference value and the second hoop mode maximum as an indicator of the current state of the section of the pipe-fluid system, the at least one physical parameter of the fluid can be derived from a difference between the first hoop mode maximum and the second hoop mode maximum. Methods for deriving the physical parameter of the fluid and/or for converting the change of the frequency into a change of fluid physical property, are described, e.g., in “Y. C. Fung: On the vibration of Thin Cylindrical Shells”, Report No AM 5-8, Oct. 14, 1955. The Ramo-Wooldrige Corporation, Guided Missile Research Division”.

This method significantly improves a non-invasive measurement of at least one physical parameter of a fluid in a pipe-fluid system. Particularly, it improves the selection of the vibration frequency that is to be used for this kind of measurement. Hence, changes of the physical property of the fluid in the pipe can be measured with low effort and high precision. Moreover, besides the physical parameters also local disturbances in the pipe may be measured, and/or alarms may be output, based on situations that may be recognized a critical for the fluid and/or for the pipe.

In various embodiments, the physical parameter is a pressure, a viscosity and/or a density of the fluid. This enables a continuous monitoring of fluids of the pipe, without a need of opening the pipe or mounting sensors within the pipe.

In various embodiments, the method comprises following alternative steps: selecting, by means of a vibration mode analysis, a first bending mode maximum out of the set of first maxima; and selecting, by means of vibration mode analysis, a second bending mode maximum out of the set of second maxima.

For determining a different kind of physical parameters, for instance for determining a flow of the fluid, these steps may substitute the respective “selecting” steps (which are to select the hoop mode maximum).

In various embodiments, the fluid is a liquid, a suspension, and/or a gas. Hence, a broad variety of material types can be measured or monitored by this method.

In various embodiments, the at least two vibration measurement devices are arranged at an outer surface of the pipe, along one line axially parallel to the pipe, and/or along one line radially circumferential to the pipe. The arrangement turned out to be particularly advantageous for both measuring Eigen-frequencies of the pipe-fluid system and for differentiating hoop mode maxima from bending mode maxima.

In various embodiments, the at least two vibration measurement devices are configured for the vibration mode analysis, particularly for classifying a first or a second maximum acquired, i.e., measured by the vibration measurement devices, either as a bending mode maximum or as a hoop mode maximum.

Further combinations, e.g., by using three sensors on a circumference of the pipe, may provide further measurement precision, e.g., by eliminating bending mode maxima, and/or by differentiating even and uneven hoop mode numbers (“n-numbers”).

In some embodiments, the vibration mode analysis is achieved by comparing a magnitude (particularly an amplitude or phase of the specific mode in the time domain).

In various embodiments, the pipe comprises or consists of metal. Pipes of metal or quite widespread and their behavior is well-known to skilled persons. In addition, many libraries—e.g., software libraries, material data sheets or material property databases—that describe their properties are available. Alternatively, the pipe may comprise or consist of another material that is able to vibrate as response to a single stimulus, e.g., by a hammer or coil system.

In some embodiments, the pipe has a diameter between 2 cm and 150 cm, and/or has a wall thickness between 2 mm and 50 mm. These are the most widespread embodiments of pipes. However, the method described here may not be limited to these dimensions.

In some embodiments, the stiff delimiter is designed as a flange or a clamp. Alternatively, the delimiter may be any entity that fixes the pipe at the two ends of the section of interest.

In various embodiments, the excitation means is designed as a hammer, a solenoid-driven coil, and/or further excitation means. At least some vibration measurement device may be able to measure also vibrations excited by other means, e.g., by knocking with a knuckle, and/or using hammer-type tools of any material.

In various embodiments, the vibration measurement device is at least one of: an accelerometer, any kind of a microphone, an optical sensor, and/or a strain gauge. The vibration measurement device may be fixed at the pipe, and/or measured from a distance, e.g., by a laser device.

An aspect relates to a vibration measurement system configured for determining a physical parameter of a fluid in a pipe-fluid system. The vibration measurement system comprises: an excitation means, configured for inducing a vibration in a section of the pipe-fluid system; at least two vibration measurement devices, configured for acquiring), from the section of the pipe-fluid system, first maxima and second maxima in an amplitude-frequency diagram; and an evaluation device, configured for executing at least some of the steps of a method of any one of the preceding claims for determining the physical parameter of the fluid.

An aspect relates to a computer program product comprising instructions, which, when the program is executed by an evaluation device, cause the computer to carry out the method as described above and/or below.

An aspect relates to a computer-readable storage medium where a computer program or a computer program product as described above is stored on.

An aspect relates to a use of a vibration measurement system described above and/or below for determining a physical parameter of a fluid in a pipe-fluid system, particularly for determining a pressure, a viscosity and/or a density of the fluid.

For further clarification, the invention is described by means of embodiments shown in the figures. These embodiments are to be considered as examples only, but not as limiting.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for determining a physical parameter of a fluid in a section of a pipe-fluid system, wherein the pipe-fluid system comprises a pipe configured to be filled with the fluid, the method comprising the steps of:
selecting the section of the pipe-fluid system, the section being delimited by a pair of stiff delimiters;
performing a numerical vibration simulation of the section of the pipe, resulting in a computed Eigen-frequency range of computed maxima of the pipe-fluid system;
inducing, by an excitation device, a first vibration of the section;
acquiring, by at least two vibration measurement devices, a set of first maxima in an amplitude-frequency diagram, with a first frequency within the computed Eigen-frequency range;
selecting, by utilizing a vibration mode analysis, a first hoop mode maximum out of the set of first maxima;
inducing, by the excitation device, a second vibration of the section;
acquiring, by the at least two vibration measurement devices, a set of second maxima in the amplitude-frequency diagram, with a second frequency within the computed Eigen-frequency range;
selecting, by utilizing vibration mode analysis, a second hoop mode maximum out of the set of second maxima;
deriving the physical parameter of the fluid from a difference between the first hoop mode maximum and the second hoop mode maximum.

2. The method of claim 1, wherein the physical parameter is a pressure, a viscosity, and/or a density and/or a flow of the fluid.

3. The method of claim 1, wherein the at least two vibration measurement devices are arranged at an outer surface of the pipe, along one line axially parallel to the pipe, and/or along one line radially circumferential to the pipe.

4. The method of claim 1, wherein the at least two vibration measurement devices are configured for the vibration mode analysis, and specifically, for classifying a first or second maximum either as a bending mode maximum or as a hoop mode maximum.

5. The method of claim 4, wherein the vibration mode analysis is achieved by comparing an amplitude and/or phase of the vibrations at the Eigen-frequencies within the set of first maxima and/or within the set of second maxima.

6. The method of claim 1, wherein the pipe comprises metal and wherein the pipe has a diameter between 2 cm and 150 cm, and a wall thickness between 2 mm and 50 mm.

7. The method of claim 1, wherein the stiff delimiter is a flange or a clamp.

8. The method of claim 1, wherein the excitation device is a hammer or a solenoid-driven coil.

9. The method of claim 1, wherein the vibration measurement device is at least one of: an accelerometer, a microphone, an optical sensor, and/or a strain gauge.

10. A method for determining a physical parameter of a fluid in a section of a pipe-fluid system, wherein the pipe-fluid system comprises a pipe configured to be filled with the fluid, the method comprising the steps of:
selecting the section of the pipe-fluid system, the section being delimited by a pair of stiff delimiters;
performing a numerical vibration simulation of the section of the pipe, resulting in a computed Eigen-frequency range of computed maxima of the pipe-fluid system;
inducing, by an excitation device, a first vibration of the section;
acquiring, by at least two vibration measurement devices, a set of first maxima in an amplitude-frequency diagram, with a first frequency within the computed Eigen-frequency range;
selecting, by means of a vibration mode analysis, a first bending mode maximum out of the set of first maxima;
inducing, by the excitation device, a second vibration of the section;
acquiring, by the at least two vibration measurement devices, a set of second maxima in the amplitude-frequency diagram, with a second frequency within the computed Eigen-frequency range;
selecting, by means of vibration mode analysis, a second bending mode maximum out of the set of second maxima; and
deriving the physical parameter of the fluid from a difference between the first hoop mode maximum and the second hoop mode maximum.

11. The method of claim 10, wherein the physical parameter is a pressure, a viscosity, and/or a density and/or a flow of the fluid.

12. The method of claim 10, wherein the at least two vibration measurement devices are arranged at an outer surface of the pipe, along one line axially parallel to the pipe, and/or along one line radially circumferential to the pipe.

13. The method of claim 10, wherein the at least two vibration measurement devices are configured for the vibration mode analysis, and specifically, for classifying a first or second maximum either as a bending mode maximum or as a hoop mode maximum.

14. The method of claim 13, wherein the vibration mode analysis is achieved by comparing an amplitude and/or phase of the vibrations at the Eigen-frequencies within the set of first maxima and/or within the set of second maxima.

15. The method of claim 10, wherein the pipe comprises metal and wherein the pipe has a diameter between 2 cm and 150 cm, and a wall thickness between 2 mm and 50 mm.

16. The method of claim 10, wherein the stiff delimiter is a flange or a clamp.

17. The method of claim 10, wherein the excitation device is a hammer or a solenoid-driven coil.

18. The method of claim 10, wherein the vibration measurement device is at least one of: an accelerometer, a microphone, an optical sensor, and/or a strain gauge.

19. A vibration measurement system configured for determining a physical parameter of a fluid in a pipe-fluid system, the vibration measurement system comprising:
an excitation device configured for inducing a vibration in a section of the pipe-fluid system;
at least two vibration measurement devices configured for acquiring from the section of the pipe-fluid system first maxima and second maxima in an amplitude-frequency diagram; and
an evaluation device configured for executing operations for determining the physical parameter of the fluid.

20. The vibration measurement system of claim 19, wherein the section of the pipe-fluid system is defined and extends between a pair of stiff delimiters.
